(19) United States
(12) Patent Application Publication
(10) Pub. No.: US 2020/0165066 A1
(43) Pub. Date: May 28, 2020

(54) CONVEYANCE ROLLER AND CONVEYANCE DEVICE

(71) Applicant: SHARP KABUSHIKI KAISHA, Sakai City, Osaka (JP)

(72) Inventor: YOSHINORI HARADA, Sakai City (JP)

(21) Appl. No.: 16/085,081

(22) PCT Filed: Mar. 8, 2017
(86) PCT No.: PCT/JP2017/009153

§ 371 Date: Sep. 14, 2018

(30) Foreign Application Priority Data
Mar. 15, 2016 (JP) 2016-051197

(51) Int. Cl. B65G 13/02; B65G 39/04

(52) U.S. Cl. CPC B65G 13/02; B65G 49/06; B65G 39/04

(57) ABSTRACT

To curb occurrence of static electricity between a glass substrate and a roller that conveys the glass substrate while supporting the glass substrate. A protrusion portion (112) is provided at a center portion of an outer circumferential surface of a roller (11) with respect to a direction in which a rotation axis (CA) of the roller (11) extends and convex portions (114) each protruding in a receding direction with respect to the rotation axis (CA) and concave portions (115) each recessed in an approaching direction with respect to the rotation axis (CA) are alternately provided along a circumferential direction (C) of the roller (11) on an outer circumference of the protrusion portion (112).

### TECHNICAL FIELD

The present invention relates to a conveyance roller that conveys a substrate such as a glass substrate of a liquid crystal display while supporting the substrate, or the like.

### BACKGROUND ART

In a resist application development system device that is used for manufacture of liquid crystal displays, a glass substrate that is a component of a liquid crystal display is conveyed while being supported by rollers attached to roller shafts. The rollers rotate so as to convey the glass substrate. On the glass substrate, thin film transistors (TFTs) that control operations of the liquid crystal display are formed.

On the glass substrate and the rollers, occurrence of triboelectric charging and separation charging then causes charge transfer and resultant changes in potential. Static electricity and electro-static discharge (ESD) thereof that are caused in such a manner exert a harmful influence on the TFTs formed on the glass substrate. Therefore, it is desirable to relieve the changes in potential.

As material of the rollers, a synthetic resin that does not scratch the glass substrate is employed. There are synthetic resin of insulating types and synthetic resin of conductive types. As measures against the ESD, a conductive resin is employed as the synthetic resin and the rollers are attached to the roller shafts grounded and made of metal. Thus generated charges are retransferred through the roller shafts so as to mitigate the changes in potential.

PTL 1 discloses a device that conveys a glass substrate by rollers attached to roller shafts. In the device, a conductive wire is wound at least once around outer rings of bearing-like pulleys provided at outer ends of the roller shafts. The conductive wire is grounded through a conductive extension spring. That is, the roller shafts are grounded through the conductive wire and the conductive extension spring.

### CITATION LIST

### Patent Literature

PTL 1: Japanese Unexamined Patent Application Publication No. 2006-36530 (laid open on Feb. 9, 2006)

### SUMMARY OF INVENTION

### Technical Problem

Recently, a shift toward higher definition of liquid crystal displays has been advancing. The higher the definition of the liquid crystal displays is, the liquid crystal displays become the more susceptible to static electricity. In addition, dimensions of glass substrates have been being increased for increase in production efficiency for liquid crystal displays. An electric charge amount that results from triboelectric charging and separation charging between a glass substrate and rollers has a tendency to increase.

It is thus becoming difficult to eliminate the changes in potential in the glass substrate and the rollers to such an extent that static electricity may not harmfully influence the TFTs formed on the glass substrate, only by grounding of the roller shafts as described in PTL 1.

In recent manufacture of liquid crystal displays, additional measures to remove static electricity, such as static elimination from glass substrates by an ionizer and application of conductive layers onto back surfaces, that is, roller-facing surfaces of the glass substrates, have been carried out.

When the TFTs are formed on the glass substrate, the glass substrate is baked. Therefore, temperatures in a device that conveys the glass substrate reach or exceed 130° C., for instance. There is no high-performance ionizer that is capable of withstanding such high temperatures and sufficiently eliminating static from the glass substrates. Besides, an enough space to install the ionizer may be absent inside the device. Furthermore, the ionizer may not be used in an atmosphere of agents that are used in the device.

In the device, the TFTs formed on the glass substrate may be harmfully influenced by deposition of the conductive layer having scattered onto the glass substrate. In order to curb scattering of the conductive layer, extensive modification of the device is demanded. Therefore, it is not desirable to apply the conductive layer onto the roller-facing surface of the glass substrate.

Above reasons may make it difficult to take such additional measures to remove the static electricity. Accordingly, it is desirable to curb occurrence of the static electricity between the glass substrate and the rollers, rather than to remove the static electricity having occurred.

In consideration of above problems, it is an object of the invention to curb the occurrence of the static electricity between the glass substrate and the rollers that convey the glass substrate while supporting the glass substrate.

### Solution to Problem

In order to cope with the above problems, a conveyance roller according to one aspect of the invention is a conveyance roller which conveys a substrate while supporting the substrate. A protrusion portion is provided at a center portion of an outer circumferential surface of the conveyance roller with respect to a direction in which a rotation axis of the conveyance roller extends, and convex portions each protruding in a receding direction with respect to the rotation axis and concave portions each recessed in an approaching direction with respect to the rotation axis are alternately provided along a circumferential direction of the conveyance roller on an outer circumference of the protrusion portion.

A conveyance device according to one aspect of the invention is a conveyance device that conveys a substrate and includes the conveyance roller according to the above-described aspect and a conveyance roller shaft to which the conveyance roller is attached.

A conveyance device according to one aspect of the invention is a conveyance device that conveys a substrate including a dielectric as a major constituent and includes a conveyance roller that conveys the substrate while supporting the substrate. The conveyance roller includes a material that is closer to the dielectric than a major constituent of the conveyance roller or identical to the dielectric in a triboelectric series.

### Advantageous Effects of Invention

According to each aspect of the invention, an effect of reducing the triboelectric charging and the separation charging between the substrate and the conveyance roller may be achieved.

### BRIEF DESCRIPTION OF DRAWINGS

FIG. 1 is a schematic diagram illustrating a configuration of a resist application development system device according to embodiment 1.

FIG. 2 is a diagram illustrating a configuration of a roller of the device illustrated in FIG. 1.

FIG. 3 is a diagram illustrating a configuration of another roller that may be used as the roller of the device illustrated in FIG. 1.

FIG. 4 is a diagram illustrating a configuration of a roller whose use as the roller of the device illustrated in FIG. 1 is undesirable.

FIG. 5 is a schematic diagram illustrating operations of the device illustrated in FIG. 1, as seen from a direction of a rotation axis of the roller.

FIG. 6 is a schematic diagram illustrating a configuration of a tester for evaluation on performance of the rollers illustrated in FIGS. 2 to 4.

FIG. 7 is a schematic diagram illustrating measurement positions for dimensions of the rollers illustrated in FIGS. 2 to 4.

FIG. 8 is a graph illustrating relationships in the tester illustrated in FIG. 6 and having the roller attached to a roller shaft, between distances with use that are distances by which the roller rolls on a vertically facing upper surface of a glass plate and electric charge amounts in the glass plate.

FIG. 9 is a graph illustrating relationships between elapsed time from start of the operations of the device illustrated in FIG. 1 and electric charge amounts in a glass substrate.

FIG. 10 is a diagram illustrating detailed configurations of the roller illustrated in FIG. 2.

FIG. 11 is a graph illustrating a relationship between contact areas between the glass substrate and the roller illustrated in FIG. 10 and the electric charge amounts in the glass substrate.

FIG. 12 is a table representing a triboelectric series that is used for selection of a material of a roller according to embodiment 2.

### DESCRIPTION OF EMBODIMENTS

### Embodiment 1

### (Liquid Crystal Display)

In the present embodiment, a liquid crystal display includes a glass substrate on which TFTs are formed. The TFTs are formed by application of photolithography to semiconductor films formed on the glass substrate. The photolithography includes following processes.

(1) Application of photoresist liquid onto a semiconductor film formed on the glass substrate
(2) Formation of a photoresist film by drying of the photoresist liquid
(3) Exposure of the photoresist film with use of a photomask
(4) Removal of exposed portions of the photoresist film by development

### (Resist Application Development System Device)

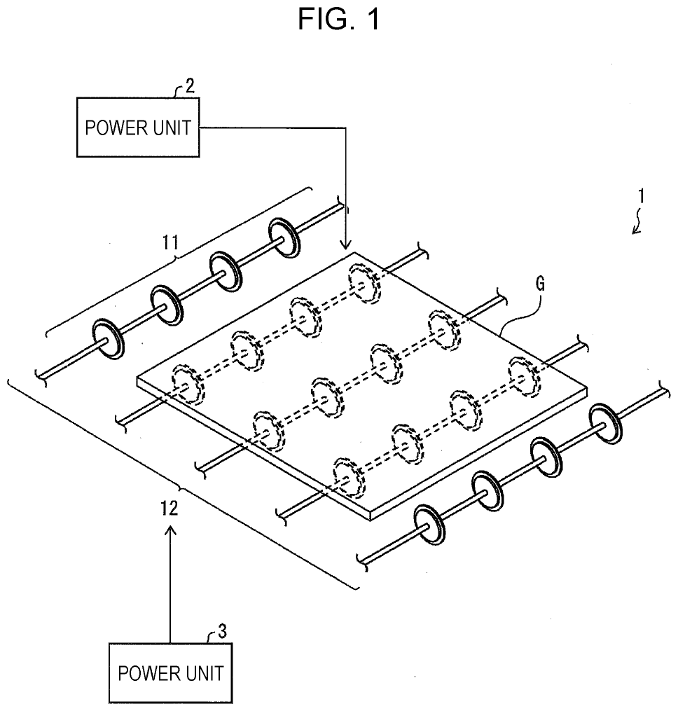

FIG. 1 is a schematic diagram illustrating a configuration of a resist application development system device 1 (conveyance device) according to the embodiment. Hereinbelow, the “resist application development system device” will be simply described as the “device”. The device 1 includes rollers 11 (conveyance rollers) and roller shafts 12 (conveyance roller shafts).

Each of the rollers 11 is a disc-shaped member and a hole is provided at center thereof. Each of the roller shafts 12 is a rod-shaped member and extends in a direction substantially perpendicular to a conveyance direction for a glass substrate G (substrate). The rollers 11 are attached to the roller shafts 12 so that the roller shafts 12 penetrate the holes of the rollers 11. Thus the rollers 11 and the roller shafts 12 to which the rollers 11 are attached are linked.

A conveyance force is given to the glass substrate G from a power unit 2. Thus the glass substrate G is conveyed while being supported by the rollers 11. The power unit 2 is a device in which a motor and a power transmission mechanism are combined.

The plurality of rollers 11 are provided in the device 1 so that the glass substrate G may not be sloped. The plurality of roller shafts 12 are provided in the device 1 so that the glass substrate G may be conveyed over a specified distance.

The conveyance force may be given to the glass substrate G not from the power unit 2 but from the rollers 11. Then rotational forces are given from a power unit 3 through the roller shafts 12 to the rollers 11. The power unit 3 is a device in which a motor and a power transmission mechanism are combined.

The device 1 having the above configuration carries out the photolithography described above while conveying the glass substrate G. In the device 1, the rollers 11 function as so-called “conveyance skids” that convey the glass substrate G while supporting the glass substrate G.

### (Roller)

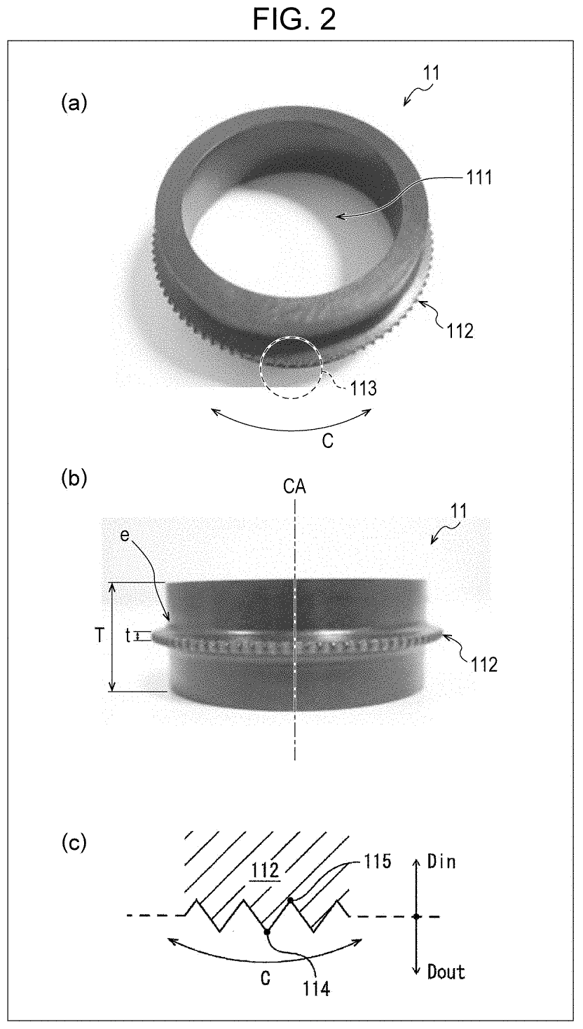

FIG. 2 is a diagram illustrating a configuration of the roller 11 of the device 1 illustrated in FIG. 1. FIG. 2(a) illustrates the configuration of the roller 11 as seen substantially from a direction of a rotation axis of the roller 11. The direction of the rotation axis of the roller means a direction in which the rotation axis of the roller extends. FIG. 2(b) illustrates the configuration of the roller 11 as seen from a direction substantially perpendicular to the rotation axis of the roller 11. In FIG. 2(b), the rotation axis of the roller 11 is illustrated with provision of characters “CA”.

A hole portion 111 is provided in the roller 11. As described above, the roller 11 is attached to the roller shaft 12 so that the roller shaft 12 (FIG. 1) penetrates the hole portion 111.

A member that intervenes between the roller 11 and the roller shaft 12 may be fitted into the hole portion 111. In such a configuration, a diameter of the hole portion 111 and a diameter of the roller shaft 12 do not have to be identical. For instance, a bearing that is a bearing to rotatably support the roller shaft 12, a coupling that is a shaft coupling to transmit power of the roller shaft 12 to the roller 11, and screws that fix those members may be fitted into the hole portion 111.

A protrusion portion 112 is provided on a center portion of an outer circumferential surface of the roller 11 with respect to the direction of the rotation axis of the roller 11. With respect to the direction of the rotation axis of the roller 11, a slit width t of the protrusion portion 112 is smaller than a roller width T of the roller 11.

FIG. 2(c) is a sectional view in which a portion 113 of FIG. 2(a) in a section perpendicular to the rotation axis CA is enlarged. On an outer circumference of the protrusion portion 112, convex portions 114 that each protrude in a receding direction Dout with respect to the rotation axis CA and concave portions 115 that are each recessed in an approaching direction Din with respect to the rotation axis CA are alternately provided along a circumferential direction C of the roller 11 so as to form slits.

A major constituent of the rollers 11 is Celazole® SPR7960 manufactured by PBI Performance Products, Inc., though not limited to this example. As the major constituent of the rollers 11, another material that may not damage the glass substrate G (FIG. 1) may be employed.

### (Modification of Roller)

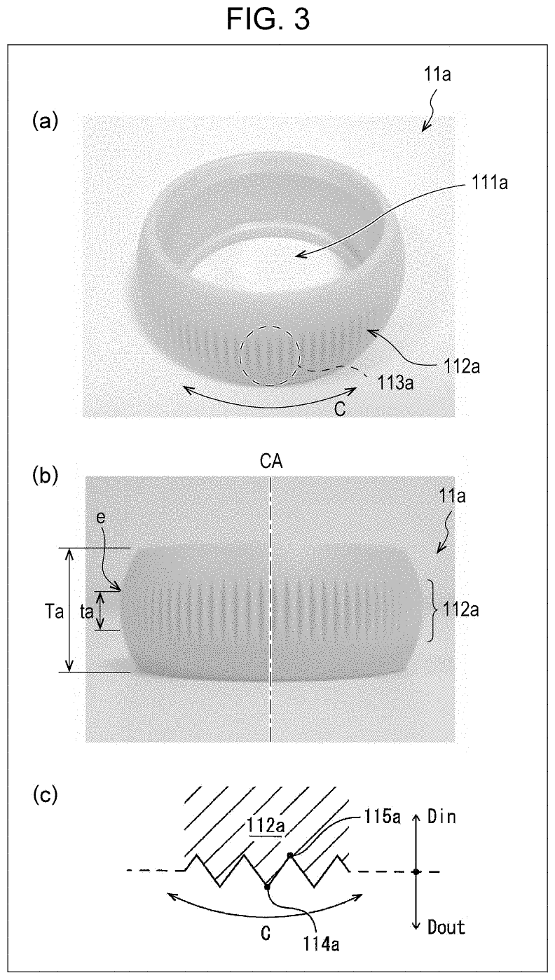

FIG. 3 is a diagram illustrating a configuration of a roller 11a (conveyance roller) that may be used as the roller 11 of the device 1 illustrated in FIG. 1. Components 111a to 115a of the roller 11a respectively correspond to components 111 to 115 of the roller 11. As with the roller 11, a slit width ta of a protrusion portion 112a is smaller than a roller width Ta of the roller 11a with respect to a direction of a rotation axis of the roller 11a. On the other hand, unlike the roller 11, diameters of the roller 11a are continuously changed on edge portions e of the protrusion portion 112a on an outer circumferential surface of the roller 11a. That is, the edge portions e are smoothed.

When the roller 11a conveys the glass substrate G, a force is exerted on the roller 11a. Thus a stress is generated inside the roller 11a. The smoothed edge portions e mitigate stress concentration in the edge portions e. As a result, the roller 11a may convey the glass substrate G more stably than the roller 11.

### (Comparative Example of Roller)

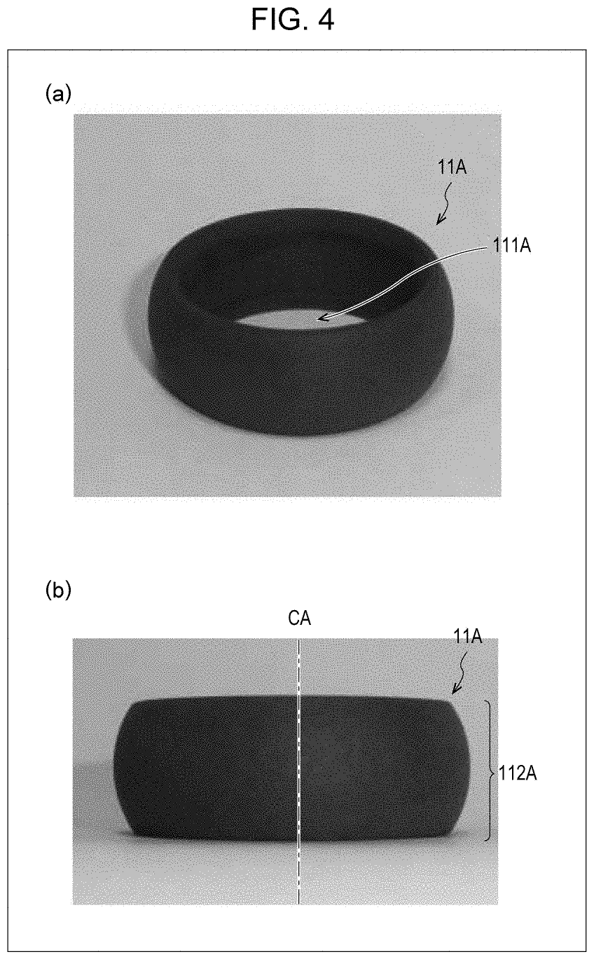

FIG. 4 is a diagram illustrating a configuration of a roller 11A (conveyance roller) whose use as the roller 11 of the device 1 illustrated in FIG. 1 is undesirable. As with the roller 11, a hole portion 111A is provided in the roller 11A. The convex portions and the concave portions, however, are not provided on an outer circumference of a protrusion portion 112A.

### (Operations of Device)

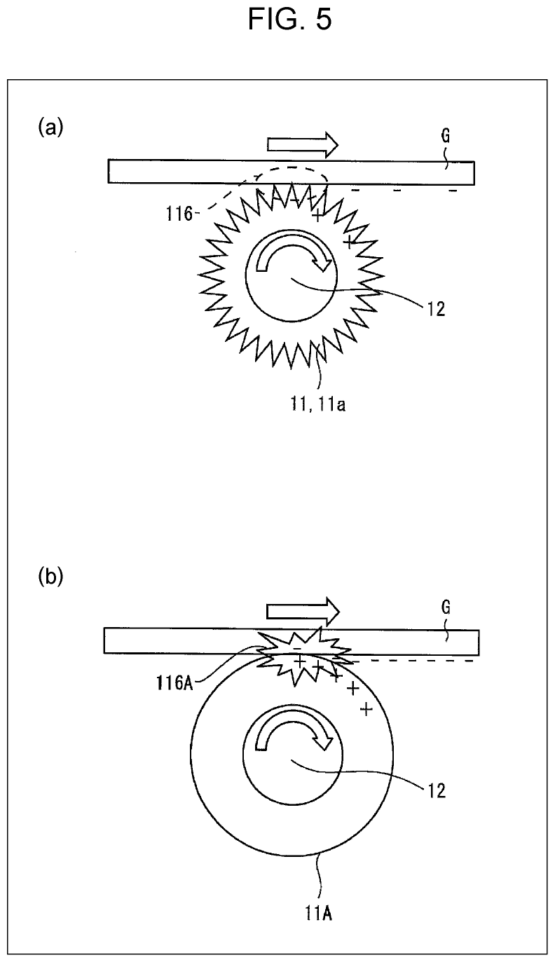

FIG. 5 is a schematic diagram illustrating operations of the device 1 illustrated in FIG. 1, as seen from the direction of the rotation axis of the roller 11. FIG. 5(a) illustrates a situation in which the device 1 includes the roller 11. In FIG. 5(a), the protrusion portion 112 of the roller 11 is depicted so as to be enlarged in comparison with actual sizes. The actual sizes are as illustrated in FIG. 2(a).

The roller 11 conveys the glass substrate G while supporting the glass substrate G. At a site 116 where the glass substrate G and the roller 11 are in contact, at this time, the glass substrate G is in contact with the convex portions 114 of the protrusion portion 112 of the roller 11. On the outer circumference of the protrusion portion 112 of the roller 11, the convex portions 114 and the concave portions 115 are alternately provided along the circumferential direction C of the roller 11. The concave portions 115 do not come into contact with the glass substrate. Therefore, continuity in the contact between the glass substrate G and the roller 11 is lost so that triboelectric charging and separation charging between the glass substrate G and the roller 11 are reduced. In the situation where the device 1 includes the roller 11a as well, triboelectric charging and separation charging between the glass substrate G and the roller 11a are similarly reduced.

### (Comparative Example of Operations of Device)

FIG. 5(b) illustrates a situation in which the device 1 imaginarily includes the roller 11A. At a site 116A where the glass substrate G and the roller 11A are in contact, the glass substrate G is in continuous contact with the protrusion portion 112A of the roller 11A. In the device 1 that uses the roller 11A to convey the glass substrate G, therefore, triboelectric charging and separation charging between the glass substrate G and the roller 11A may not be reduced.

### (Performance Evaluation Using Tester)

### <Configuration of Tester>

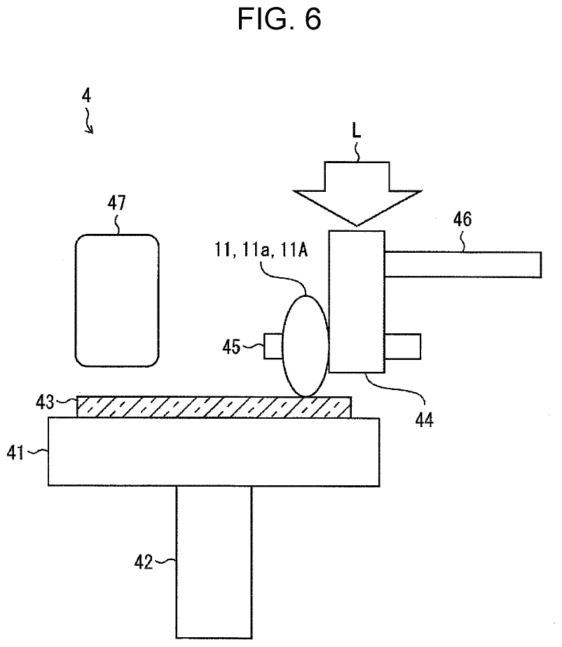

FIG. 6 is a schematic diagram illustrating a configuration of a tester 4 for evaluation on performance of the rollers illustrated in FIGS. 2 to 4.

The tester 4 includes a rotating stage 41, a rotating shaft 42, a glass plate 43, a load member 44, a roller shaft 45, a shaft 46, and an electrostatic measuring instrument 47.

The rotating shaft 42 is connected to a vertically facing lower surface of the rotating stage 41. With rotation of the rotating shaft 42, the rotating stage 41 rotates in a rotational direction of the rotating shaft 42.

The glass plate 43 is adsorbed onto a vertically facing upper surface of the rotating stage 41. A material of the glass plate 43 is the same as a material of the glass substrate G described above.

The roller shaft 45 is rotatably fixed to the load member 44. The above-described roller 11, 11a, or 11A is attached to the roller shaft 45. Then a load L is exerted on the load member 44. Thus the roller is pressed against the glass plate 43. By adjustment in the load L exerted on the load member 44, a load exerted on the glass plate 43 by the roller may be adjusted.

The load member 44 is movable in vertical directions. With movement of the load member 44 in the vertical downward direction, the roller attached to the roller shaft 45 approaches the glass plate 43. With movement of the load member 44 in the vertical upward direction, the roller attached to the roller shaft 45 recedes from the glass plate 43. Thus a height of the roller relative to the glass plate 43 may be adjusted.

One end side of the shaft 46 is fixed to the load member 44. The other end side of the shaft 46 is supported by a member not illustrated.

The electrostatic measuring instrument 47 is a measuring instrument for measurement of an electric charge amount in the glass plate 43 and is an electrostatic measuring instrument SK050 manufactured by KEYENCE CORPORATION, though not limited thereto.

The tester 4 is installed in a sealed case that covers the tester 4. A humidity in the case is controlled so as to be as high as a humidity of an environment in which the above-described device 1 is installed.

The above configuration makes it possible for the roller to roll on the vertically facing upper surface of the glass plate 43 while maintaining a state in which the load L is exerted on the glass plate 43. The tester 4 may be adjusted so that the load L exerted by the roller on the glass plate 43 may be equal to a load exerted by the roller on the glass substrate G in the device 1. Thus the tester 4 is capable of reproducing the operations of the device 1 illustrated in FIG. 5.

### <Test Object>

TABLE 1

| | Roller 11 | Roller 11a | Roller 11A |
|---|---|---|---|
| Material | Celazole | Celazole | Celazole |
| Angle θ | 60° | 90° | None |
| Groove depth de | 1 mm | 0.5 mm | None |
| Pitch p | 4° | 4° | None |
| End portion diameter | 31 mm | 31 mm | 31 mm |
| E, Ea | | | |
| Center portion diameter | 35 mm | 35 mm | 35 mm |
| D, Da | | | |
| Roller width T, Ta | 12 mm | 12 mm | 12 mm |
| Slit width t, ta | 2 mm | 4 mm | None |

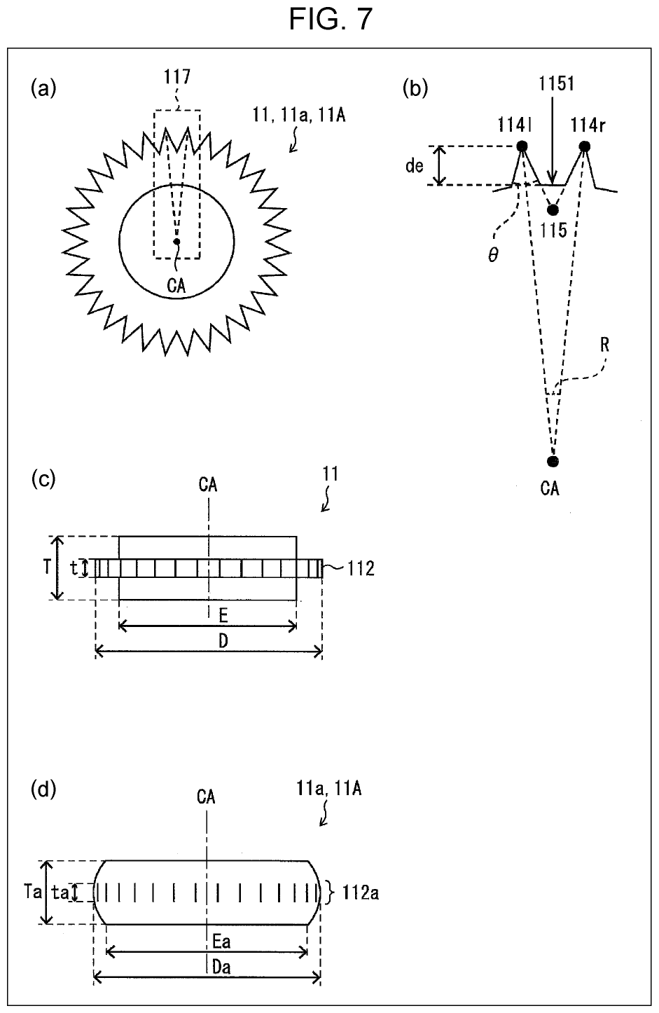

Table 1 indicates dimensions of the rollers 11, 11a, and 11A illustrated in FIGS. 2 to 4. FIG. 7 is a schematic diagram illustrating measurement positions for the dimensions of the rollers 11, 11a, and 11A illustrated in FIGS. 2 to 4. FIG. 7(b) is a sectional view in which a portion 117 of FIG. 7(a) in a section perpendicular to the rotation axis CA of each roller is enlarged. The dimensions of each roller in the section are defined as follows.

Angle θ: an angle of a convex portion 1141
Groove depth de: a length between a flat concave portion 1151 (concave portion 115 in case where the concave portions are point-like) and the convex portion 1141 in a direction in which a straight line passing through the rotation axis CA and the concave portion 115 extends
Pitch p: an angle made by a line segment that links the rotation axis CA and the convex portion 1141 and a line segment that links the rotation axis CA and a convex portion 114r

As illustrated in FIG. 7(b), the flat concave portions 1151 may be provided in place of the concave portions 115 on the protrusion portion of the roller. The dimensions in Table 1 may be defined for both the roller including the protrusion portion provided with the concave portions 115 and the roller including the protrusion portion provided with the flat concave portions 1151.

It can be said that the “angle θ” is an angle of the concave portions. That is, it can be said that the “angle θ” is an angle made by a line segment that links the concave portion 115 and the convex portion 1141 adjoining the concave portion 115 and a line segment that links the concave portion 115 and the convex portion 114r adjoining the concave portion 115 and different from the convex portion 1141.

There are the plurality of convex portions on the roller. The “angle θ” may have a different value for each convex portion. In the embodiment, all the “angles θ” in one roller are substantially the same. The same applies to the “groove depth de” and the “pitch p”. The rollers of the embodiment are manufactured by a compression molding process in which a synthetic resin as the material of the rollers is sealed in molds, the synthetic resin is melted by heating and pressurization of the molds, and the synthetic resin is solidified by cooling of the molds.

FIG. 7(c) illustrates a situation of the roller 11 as seen from the direction perpendicular to the rotation axis CA of the roller 11. Dimensions in a section of the roller 11 are defined as follows.

End portion diameter E: a diameter of an end portion of the roller 11 with respect to the direction of the rotation axis
Center portion diameter D: a diameter of a center portion of the roller 11 with respect to the direction of the rotation axis
Roller width T: a length of the roller 11 in the direction of the rotation axis
Slit width t: a length of the protrusion portion 112 in the direction of the rotation axis of the roller 11

FIG. 7(d) illustrates a situation of the roller 11a, 11A as seen from the direction perpendicular to the rotation axis CA. Dimensions in a section of the roller 11a, 11A are defined as follows. The “slit width” does not exist in the roller 11A.

End portion diameter Ea: a diameter of an end portion of the roller 11a, 11A with respect to the direction of the rotation axis
Center portion diameter Da: a diameter of a center portion of the roller 11a, 11A with respect to the direction of the rotation axis
Roller width Ta: a length of the roller 11a, 11A in the direction of the rotation axis
Slit width ta: a length of the protrusion portion 112a in the direction of the rotation axis of the roller 11a

### <Test Results>

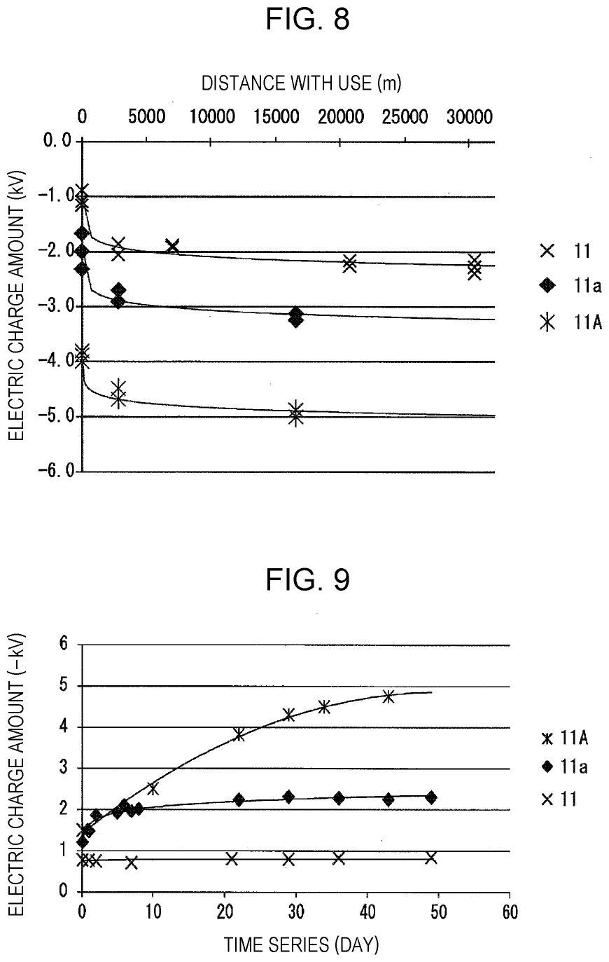

FIG. 8 is a graph illustrating relationships in the tester 4, illustrated in FIG. 6 and having the roller 11, 11a, 11A with the dimensions indicated in Table 1 attached to the roller shaft 45, between distances with use that are distances by which the roller rolls on the vertically facing upper surface of the glass plate 43 and the electric charge amounts in the glass plate 43. A horizontal axis in FIG. 8 represents the distances with use. A vertical axis in FIG. 8 represents the electric charge amounts. In FIG. 8, data points each composed of the distance with use and the electric charge amount and curves of continuous functions approximated to the data points are illustrated.

The electric charge amount in the glass plate 43 is −5.0 kV on condition that the roller 11A has rolled by 30000 m on the vertically facing upper surface of the glass plate 43, for instance. The electric charge amount in the glass plate 43 is −3.2 kV on condition that the roller 11a has rolled by 30000 m on the vertically facing upper surface of the glass plate 43. The electric charge amount in the glass plate 43 is −2.2 kV on condition that the roller 11 has rolled by 30000 m on the vertically facing upper surface of the glass plate 43.

Thus the electric charge amount in the tester 4 in which the roller 11 or 11a is attached to the roller shaft 45 is smaller than the electric charge amount in the tester 4 in which the roller 11A is attached to the roller shaft 45. Furthermore, the electric charge amount in the tester 4 in which the roller 11 is attached to the roller shaft 45 is still smaller than the electric charge amount in the tester 4 in which the roller 11a is attached to the roller shaft 45.

### (Performance Evaluation Using Actual Device)

With the device 1 including the above-described roller 11, 11a, 11A actually operated, an evaluation of the performance of each of the rollers was made by measurement of the electric charge amount in the glass substrate G. The dimensions of the rollers 11, 11a, and 11A used for the evaluation were as indicated in Table 1.

### <Operating Condition for Device>

Dimensions of the glass substrate G: length in the conveyance direction 2460 mm; width 2160 mm; thickness 0.5 to 1.1 mm
Conveyance velocity for the glass substrate G: 50 mm/s Dimensions of the roller shaft 12: length 2745 mm; diameter 25 mm
Arrangement interval of the roller shafts 12: 162 mm Number of the rollers attached to one of the roller shafts 12: 14

### <Method of Measuring Electric Charge Amount in Glass Substrate>

The electric charge amount in the glass substrate G was measured with use of the electrostatic measuring instrument SK050 manufactured by KEYENCE CORPORATION, not limited thereto, at a position 10 mm distant from the roller-facing surface in a direction perpendicular thereto in an area not including the rollers and the roller shafts 12 on a side of the roller-facing surface, that is, a back surface of the glass substrate G being conveyed.

### <Results of Performance Evaluation>

FIG. 9 is a graph illustrating relationships between elapsed time from start of the operations of the device 1 illustrated in FIG. 1 and the electric charges amount in the glass substrate G. A horizontal axis in FIG. 9 represents a number of days that had elapsed from the start of the operations of the device 1. A vertical axis in FIG. 9 represents the electric charge amount in the glass substrate G. In FIG. 9, data points each composed of the elapsed time and the electric charge amount and curves of continuous functions approximated to the data points are illustrated.

On the 49-th day after activation of the device 1, for instance, the electric charge amount in the device 1 including the rollers 11A was −4.76 kV. The electric charge amount in the device 1 including the rollers 11a was −2.30 kV. The electric charge amount in the device 1 including the rollers 11 was −0.85 kV.

As described above, the electric charge amount in the device 1 including the rollers 11 or 11a was smaller than the electric charge amount in the device 1 including the rollers 11A. Furthermore, the electric charge amount in the device 1 including the rollers 11 was still smaller than the electric charge amount in the device including the rollers 11a.

### Effects of Present Embodiment

On the outer circumferences of the protrusion portions of the rollers 11 and 11a, the convex portions and the concave portions are alternately provided along the circumferential direction of the rollers. The concave portions do not come into contact with the glass substrate G. Therefore, the continuity is lost in the contact between the glass substrate G and the rollers, so that the triboelectric charging and the separation charging between the glass substrate G and the rollers are reduced.

By provision of the rollers 11 or 11a in the device 1, the electric charge amount in the glass substrate G may be reduced in a conveyance unit for which it is difficult to take measures against charging, such as an ionizer, even though the roller shafts 12 are not grounded. Specifically, a process of making convexity and slits on the rollers removes the continuity from the contact between the rollers and the glass substrate G, so that the triboelectric charging and the separation charging between the rollers and the glass substrate G are reduced. Resultant curbing on ESD-related failures in liquid crystal displays may contribute to yield improvement.

In order to reduce the charging in the glass substrate G to the same extent as in the embodiment, conventionally, investments and modifications in large scale, such as application of an antistatic agent onto the roller-facing surface of the glass substrate G, have been demanded. In the embodiment, the charging in the glass substrate G may be reduced by an investment in a smaller scale than conventionally demanded.

### (Reduction of Scratches on Glass)

In general, the glass substrate G may be damaged by foreign matter, harder than glass, caught between the glass substrate G and the rollers 11 or 11a. In the device 1, by contrast, the continuity in the contact between the glass substrate G and the rollers is lost, so that catches of foreign matter, including glass chips, may be reduced. As a result, glass scratches on the glass substrate G may be reduced.

### (Process of Conveying Glass Substrate)

The invention may be widely applied to processes and devices that involve roller conveyance of a substrate. That is, the invention may be applied not only to the above-described processes and device 1 in which the photolithography is applied to the semiconductor films formed on the glass substrate G but also to processes and devices in which a substrate is cleaned, and the like.

### (Contact Area Between Glass Substrate and Roller)

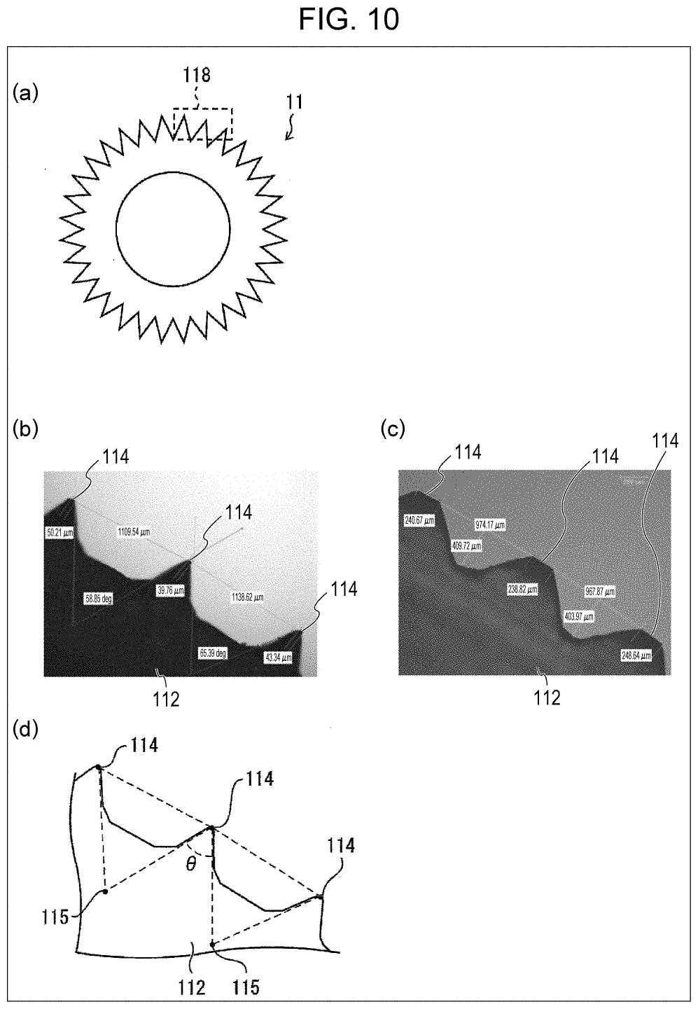

FIG. 10 is a diagram illustrating detailed configurations of the roller 11 illustrated in FIG. 2. FIG. 10(a) is a schematic diagram illustrating a configuration of the roller 11, as seen from the direction of the rotation axis of the roller 11. In FIG. 10(a), the protrusion portion 112 of the roller 11 is depicted so as to be enlarged in comparison with the actual sizes. The actual sizes are as illustrated in FIG. 2(a).

FIG. 10(b) illustrates an example of an image of the roller 11 in which a portion 118 of FIG. 10(a) is enlarged. FIG. 10(c) illustrates an example of an image of the roller 11 in which the portion 118 of FIG. 10(a) is enlarged and which is different from the image illustrated in FIG. 10(a).

A contact area between the glass substrate G and the roller 11 depends on a shape of the convex portion 114 of the protrusion portion 112. The convex portion 114 in FIG. 10(b) is smaller in the contact area than the convex portion 114 in FIG. 10(c).

FIG. 10(d) is a schematic diagram in which auxiliary lines are added to the image illustrated in FIG. 10(b). In the protrusion portion 112, the shape of the convex portion 114 and a shape of the concave portion 115 are not necessarily clear as illustrated in FIG. 2(c). In case where the shape of the convex portion 114 and the shape of the concave portion 115 are not clear, positions of the convex portions 114 and positions of the concave portions 115 may be identified by addition of the auxiliary lines as illustrated by dashed lines in FIG. 10(d). Thus a contact length between the glass substrate G and the roller as seen from the direction of the rotation axis of the roller 11 is found. The contact area between the glass substrate G and the rollers 11 can be found by multiplication of the contact length, a contact width that is a contact length of the protrusion portion 112 along the direction of the rotation axis of the roller 11, and a number of the protrusion portions 112 that may be in contact with the glass substrate G.

### (Shape of Roller in Consideration of Electric Charge Amount)

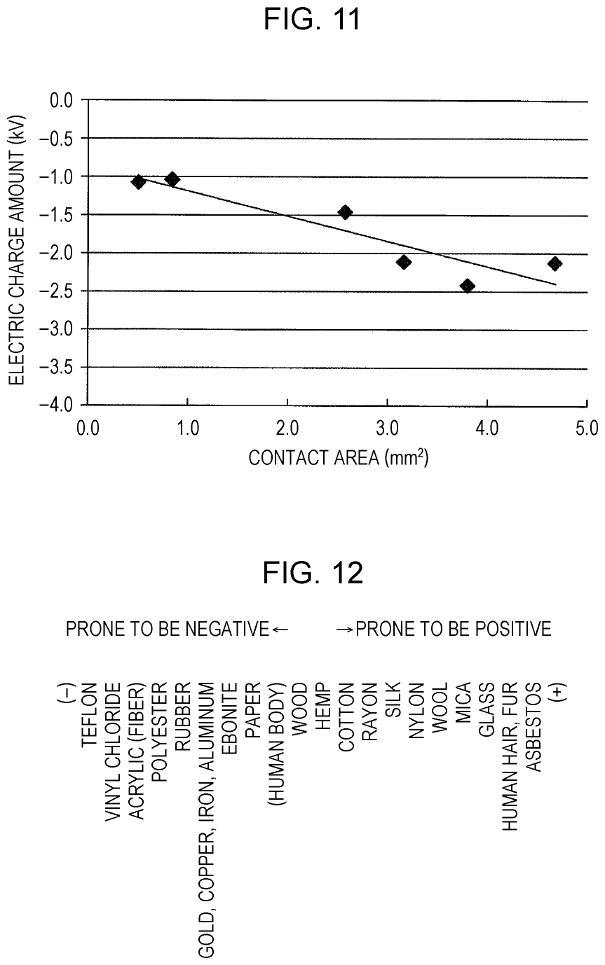

FIG. 11 is a graph illustrating a relationship between the contact areas between the glass substrate G and the roller 11 illustrated in FIG. 10 and the electric charge amounts in the glass substrate G. A horizontal axis in FIG. 11 represents the contact areas. A vertical axis in FIG. 11 represents the electric charge amounts.

The electric charge amount in the glass substrate G was measured with use of the electrostatic measuring instrument SK050 manufactured by KEYENCE CORPORATION, not limited thereto, at a position 10 mm distant from the roller-facing surface in the direction perpendicular thereto in an area not including the rollers and the roller shafts 12 on the side of the roller-facing surface, that is, the back surface of the glass substrate G being conveyed.

The inventor found a positive correlation between the contact areas between the glass substrate G and the roller 11 and absolute values of the electric charge amounts in the glass substrate G as illustrated in FIG. 11. That is, as the contact area decreases, the absolute value of the electric charge amount also decreases.

The convex portions 114 of the protrusion portion 112 of the roller 11 are worn with the conveyance of the glass substrate G. As the convex portions 114 are worn, the contact area between the glass substrate G and the roller 11 increases. Therefore, it is desirable for the angle of the convex portion to be as small as possible so that the contact area may be kept as small as possible even though the convex portion is worn. A limit value that may be adopted as the angle of the convex portion exists because a machining accuracy for the roller 11 is limited. The roller 11 in which the limit value is adopted as the angle of the convex portion is also encompassed by the invention.

### (Effects of Flat Concave Portions)

Provided that the concave portions of the protrusion portion of the roller are flattened as illustrated in FIGS. 7(b) and 10(b), the above-described “pitch p” may be increased while the angle of the convex portions is kept small. Thus a number of the convex portions that may be in contact with the glass substrate G may be reduced. The roller including the protrusion portion provided with the flat concave portions is encompassed by the invention.

### (Effects of Shape of Edge Portions)

As illustrated in FIG. 2(b), edge portions e of the protrusion portion 112 on the outer circumferential surface of the roller 11 have a concave shape. The protrusion portion 112 protrudes outward farther with respect to the roller 11 than in the roller 11a (FIG. 3). Therefore, the slit width t of the protrusion portion 112 along the direction of the rotation axis of the roller 11 may be made smaller than the slit width ta of the protrusion portion 112a along the direction of the rotation axis of the roller 11a. As a result, the contact area between the glass substrate G and the roller 11 may be made smaller than the contact area between the glass substrate G and the roller 11a.

As illustrated in FIG. 11, the smaller the contact area between the glass substrate G and the roller is, the smaller the electric charge amount in the glass substrate G is. Accordingly, the device 1 including the rollers 11 excels the device 1 including the rollers 11a in performance for charging reduction.

### Embodiment 2

Members having the same functions as members described for the embodiment 1 have are designated by the same reference characters and description thereon is omitted.

### (Triboelectric Series)

FIG. 12 is a table representing a triboelectric series that is used for selection of a material of the rollers 11 in the embodiment. The triboelectric series refers to an order based on friction between two types of materials in which a material that is prone to be positively charged is ranked higher and a material that is prone to be negatively charged is ranked lower.

The more distant the two types of materials that are frictioned are from each other in the triboelectric series, the more charges are transferred. In case where the two types of materials are near to each other in the triboelectric series, the charge transfer may not occur or a transfer reverse to the charge transfer indicated by the triboelectric series may occur. The above depends on presence of the friction, presence of contaminants, oxides, or the like, properties of substances other than the materials, and the like.

The above-described rollers 11 cause friction with the glass substrate G when conveying the glass substrate G. On condition that the rollers 11 include a material distant from glass that is a major constituent of the glass substrate G in the triboelectric series, therefore, the electric charge amount in the glass substrate G increases.

### (Optimization of Composition of Roller)

TABLE 2

| | Working | Comparative | Comparative |
|---|---|---|---|
| | example 1 | example 1 | example 2 |
| Material | PEEK | PEEK | PEI |
| Ceramic filler | Included | Not included | Not included |
| inclusion | | | |
| Electric charge | −0.16 | −0.48 | −2.00 |
| amount (kV) | | | |

Table 2 is a table representing a relationship between composition of the rollers 11 and the electric charge amount in the glass substrate G under a condition that the device 1 including the rollers 11 with the composition is operated as illustrated in FIG. 5. Meanings of items in Table 2 are as follows.

Material: following materials as the major constituent of the rollers 11
PEEK: PEEK450G, which is a resin based on polyetheretherketone (PEEK) and manufactured by Victrex plc
PBI: SPR7960, which is a resin based on polybenzimidazole (PBI) and manufactured by PBI Performance Products, Inc.

The electric charge amount in the glass substrate G was measured with use of the electrostatic measuring instrument SK050 manufactured by KEYENCE CORPORATION, not limited thereto, at a position 10 mm distant from the roller-facing surface in the direction perpendicular thereto in an area not including the rollers and the roller shafts 12 on the side of the roller-facing surface, that is, the back surface of the glass substrate G being conveyed.

### Effects of Present Embodiment

As indicated in Table 2, the electric charge amount in the glass substrate G with use of the rollers 11 of working example 1 including ceramic filler with the same composition as glass that is the major constituent of the glass substrate G is smaller than the electric charge amount in the glass substrate G with use of the rollers 11 of comparative example 1 or 2 not including the ceramic filler. The electric charge amount in the glass substrate G with use of the rollers 11 of working example 1 is smaller than the electric charge amount in the glass substrate G with use of the rollers 11 of comparative example 1 having the same major constituent.

That is, an effect of reducing the charging in the glass substrate G may be achieved by the rollers 11 of working example 1 that include the ceramic filler with the composition close or identical to the major constituent of the glass substrate G in the triboelectric series.

An object to be conveyed by the rollers 11 is not limited to a glass substrate and may be a substrate including a dielectric other than glass as a major constituent. In this case, the charging in the glass substrate G may be reduced by the rollers 11 including a material that is closer to the dielectric than the major constituent of the rollers 11 or identical to the dielectric in the triboelectric series. As described above, the inventor found out a novel material, to be included in the rollers 11, which makes the glass substrate G resist the charging.

### CONCLUSION

The conveyance roller (roller 11, 11a) according to aspect 1 of the invention is a conveyance roller which conveys a substrate (glass substrate G) while supporting the substrate. The protrusion portion 112, 112a is provided at the center portion of the outer circumferential surface of the conveyance roller with respect to the direction in which the rotation axis of the conveyance roller extends, and the convex portions 114, 114a each protruding in the receding direction with respect to the rotation axis and the concave portions 115, 115a each recessed in the approaching direction with respect to the rotation axis are alternately provided along the circumferential direction of the conveyance roller on the outer circumference of the protrusion portion.

According to the above configuration, the conveyance roller conveys the substrate while supporting the substrate and thus the convex portions of the protrusion portion of the conveyance roller come into contact with the substrate. By contrast, the concave portions of the protrusion portion do not come into contact with the substrate. On the outer circumference of the protrusion portion, the convex portions and the concave portions are alternately provided along the circumferential direction of the conveyance roller. Therefore, the continuity in the contact between the substrate and the conveyance roller is lost, so that the triboelectric charging and the separation charging between the substrate and the conveyance roller are reduced.

In the conveyance roller according to aspect 2 of the invention, it is desirable that the dimension of the protrusion portion is smaller than the dimension of the conveyance roller in the direction of the rotation axis, in the aspect 1.

In the conveyance roller according to aspect 3 of the invention, it is desirable that the edge portions of the protrusion portion on the outer circumferential surface each have the concave shape, in the aspect 1 or 2.

According to the above configuration, the protrusion portion may protrude outward farther with respect to the conveyance roller. Therefore, the dimension of the protrusion portion along the direction of the rotation axis of the conveyance roller may be further reduced. As a result, the contact area between the substrate and the conveyance roller may be further reduced.

In the conveyance roller according to aspect 4 of the invention, it is desirable that the diameters of the conveyance roller are continuously changed on the edge portions of the protrusion portion on the outer circumferential surface, in the aspect 1 or 2.

According to the above configuration, the force is exerted on the conveyance roller when the conveyance roller conveys the substrate. Thus the stress is generated inside the conveyance roller. The smoothed edge portions may mitigate stress concentration in the edge portions. As a result, the roller may convey the substrate more stably.

In the conveyance roller according to aspect 5 of the invention, it is desirable that the concave portions are flat.

According to the above configuration, the pitch may be increased while the angle of the convex portions is kept small. Thus the number of the convex portions that may be in contact with the substrate may be reduced.

The conveyance device (resist application development system device 1) according to aspect 6 of the invention is a conveyance device that conveys a substrate and includes the conveyance roller according to any one of the above aspects 1 to 5 and the conveyance roller shaft (roller shaft 12) to which the conveyance roller is attached.

In the conveyance device according to aspect 7 of the invention, it is desirable that the conveyance device conveys a substrate including a dielectric as a major constituent and the conveyance roller includes a material that is closer to the dielectric than the major constituent of the conveyance roller or identical to the dielectric in the triboelectric series, in the above aspect 6.

The triboelectric series refers to the order based on the friction between two types of materials in which a material that is prone to be positively charged is ranked higher and a material that is prone to be negatively charged is ranked lower.

According to the above configuration, the dielectric that is the major constituent of the substrate and the material included in the conveyance roller are close or identical to each other in the triboelectric series. Therefore, the charging in the substrate and the conveyance roller may be reduced.

The conveyance device according to aspect 8 of the invention is a conveyance device that conveys a substrate including a dielectric as the major constituent and includes the conveyance roller (roller 11, 11a, 11A) that conveys the substrate while supporting the substrate. The conveyance roller includes a material that is closer to the dielectric than the major constituent of the conveyance roller or identical to the dielectric in the triboelectric series.

### APPENDIX

The invention is not limited to the embodiments described above and may be embodied with various modifications within the scope disclosed in the claims. Embodiments obtained by appropriate combination of technical means disclosed in different embodiments are also encompassed by the technical scope of the invention. Further, new technical characteristics may be formed by combination of technical means disclosed in the embodiments.

### REFERENCE SIGNS LIST

1 resist application development system device (conveyance device)
11, 11a, 11A roller (conveyance roller)
12 roller shaft
112, 112a protrusion portion
114, 114a convex portion
115, 115a concave portion
1151 flat concave portion (concave portion)
G glass substrate (substrate)

1. A conveyance roller that conveys a substrate while supporting the substrate, wherein
a protrusion portion is provided at a center portion of an outer circumferential surface of the conveyance roller with respect to a direction in which a rotation axis of the conveyance roller extends, and
convex portions each protruding in a receding direction with respect to the rotation axis and concave portions each recessed in an approaching direction with respect to the rotation axis are alternately provided along a circumferential direction of the conveyance roller on an outer circumference of the protrusion portion.

2. The conveyance roller according to claim 1, wherein a dimension of the protrusion portion is smaller than a dimension of the conveyance roller in the direction of the rotation axis.

3. The conveyance roller according to claim 1, wherein edge portions of the protrusion portion on the outer circumferential surface each have a concave shape.

4. The conveyance roller according to claim 1, wherein diameters of the conveyance roller are continuously changed on the edge portions of the protrusion portion on the outer circumferential surface.

5. The conveyance roller according to claim 1, wherein the concave portions are flat.

6. A conveyance device that conveys a substrate, the conveyance device comprising:
the conveyance roller according to claim 1; and
a conveyance roller shaft to which the conveyance roller is attached.

7. The conveyance device according to claim 6, wherein
the conveyance device conveys a substrate including a dielectric as a major constituent, and
the conveyance roller includes a material that is closer to the dielectric than a major constituent of the conveyance roller or identical to the dielectric in a triboelectric series.

8. A conveyance device that conveys a substrate including a dielectric as a major constituent, the conveyance device comprising:
a conveyance roller that conveys the substrate while supporting the substrate, wherein
the conveyance roller includes a material that is closer to the dielectric than a major constituent of the conveyance roller or identical to the dielectric in a triboelectric series.
